(19) United States
(12) Patent Application Publication
(10) Pub. No.: US 2012/0091093 A1
(43) Pub. Date: Apr. 19, 2012

(54) MANUFACTURE OF CLOSURES FOR FOOD CONTAINERS

(75) Inventors: Gerry Patrick Doyle, Oxfordshire (GB); Peter Frank Woodward, Oxfordshire (GB)

(73) Assignee: CROWN PACKAGING TECHNOLOGY, INC., ALSIP, IL (US)

(21) Appl. No.: 13/375,017

(22) PCT Filed: May 5, 2010
(86) PCT No.: PCT/EP10/56085

§ 371 Date: Nov. 29, 2011

(30) Foreign Application Priority Data
May 29, 2009 (EP) 09161558.3

(51) Int. Cl. B65D 43/00; B29C 35/02; B29C 67/00; B65D 53/00; B30B 11/00

(52) U.S. Cl. 215/341; 425/457; 264/319

(57) ABSTRACT

An apparatus and method for the manufacture of closures, which are used for closing containers such as glass jars for food. During manufacture, it is essential that sealing compound is prevented from ingress onto the centre of the closure as such ingress could lead to possible contamination of the food. The sealing apparatus and, in particular, the sealing punch of the present invention have features which achieve this control.

### TECHNICAL FIELD

This invention relates to the manufacture of closures which are used for closing containers, for example glass jars. These containers often hold food products, including such items as baby food or other food which must be packaged under strict legal standards, including e.g. sterilisation, pasteurisation etc. One of the major aims of a food closure manufacturer is to ensure that the placement of the lining compound is controlled to minimise contact with the food and to minimise the risk of detachment of the compound and subsequent contamination of the food.

### BACKGROUND ART

One type of closure for products such as food is a “press twist” (“PT”) style of closure, which is a metal vacuum closure applied to a container by pressing onto the container's open end and removing by twisting off the container. A known PT closure comprises a metal end panel and skirt, or sidewall, constructed in a single piece from coated metal, typically tinplate. Sidewall compound provides infestation and abuse resistance. This lining compound (sometimes referred to simply as “lining”, “compound” or “gasket material”) is moulded in the closure so as to provide hermetic sealing of the container to which the closure is fixed.

The present invention is principally intended for the formation of a lining compound or gasket by moulding of lining compound directly in a closure.

### DISCLOSURE OF INVENTION

According to a first aspect of the present invention, there is provided an apparatus for moulding lining or gasket material in a closure shell, the shell comprising an end panel and skirt extending from the end panel, in which the apparatus comprises: an anvil for supporting the shell in its inverted position with the skirt extending upwardly; and a punch having an inner part for holding the closure shell and an outer part for moulding the lining material, the inner part of the punch being axially moveable relative to the outer part, in which the inner part is a compliant component which is adapted, in use, to provide annular shut-off to limit dispersion of the lining or gasket material inboard of the shut-off and the outer part has a profile which is adapted for moulding of the lining or gasket material.

The crux of the invention is the split functionality of the two parts of the punch. Thus the inner part provides shut-off and the outer part provides moulding. Although these have been referred to herein as “inner” and “outer” parts of the punch, those terms are not intended to limit the punch to two distinct tooling parts but could also include a single tooling part which is equivalent to the “outer” part and any compliant component, not necessarily solid sprung tooling. Thus the compliant component would be equivalent to the “inner” part and would be set in the tooling to provide the function of shut-off. This compliant part may be an ‘O’-ring or other compressible material, set within a lower face of the outer punch part.

Usually, however, the inner part is compliant tooling with mechanical biasing features such as springs. In this embodiment, the inner part may have a profile which has its leading edge at a radially outward position; and the outer part may have a profile which has its leading edge at a radially inward position; and in which, in use, when the punch is used for moulding, the leading edge of the inner part forms a shut-off point for limiting dispersion of the gasket or lining material.

The apparatus of the invention thus prevents compound from running past the shut-off point before moulding starts. Preferably, both of the inner and outer punch parts may be coated with a coating selected so as to prevent build up of lining material during moulding. Usually, the outer punch is fixed concentrically and the inner punch part is biased, for example by the springs, towards the anvil.

In its pre-loaded position, the inner punch part may protrude from the outer punch part. The anvil usually also includes a biasing feature such as one or more springs which, when the punch is loaded, bias the inner punch towards a home position. This home position may be defined by a back plate, which may be an independent component of the punch or, more usually, is a part of the distal end of the outer punch part.

The invention also provides a method of moulding lining or gasket compound in a closure shell, the shell comprising an end panel and skirt extending from the end panel, in which the method comprises: introducing lining compound onto the inner wall of the skirt of the shell; supporting the closure shell in its inverted, skirt uppermost, position on an anvil; lifting the closure into contact with an inner part of a punch; sealing an annular channel of the closure by a compressible inner part of the punch; and, after the sealing step has provided shut-off, moulding the compound around the inner skirt wall of the closure shell and, optionally, onto an outer annulus of the end panel.

The method may further comprise biasing the anvil against an opposing biasing force from the punch, the biasing forces being provided by spring loading and/or by resilient material.

In one embodiment, the inner part of the punch may have an array of equi-spaced springs, disposed concentrically and extending axially around the inner part. These springs maintain contact between the punch and the shell surface during moulding. The anvil will also typically include one or more biasing features such as springs which bias the closure shell towards the punch home position. The net force of punch and anvil springs is balanced during moulding to prevent flashing of compound onto the centre of the closure shell end panel. The anvil spring(s) provides compliance once the home position of the inner punch is reached and the punch load is therefore slightly less than the anvil loading to achieve this. The clamping force between punch inner and anvil thus holds the punch position, takes up anvil load and also absorbs moulding pressure.

The method may further comprise compound control, i.e. controlling the amount of compound in the shell and/or the placement of the compound on the shell wall when it is applied to the closure shell wall.

Ideally, the punch is heated. This heat skins and at least partially cures the compound during moulding.

It is preferred that the inner punch part is moveable and the outer part is “fixed” radially. Preferably, the outer part of the punch includes an integral back plate and the inner punch is biased into a position which is axially displaced towards the anvil. The biasing part of the punch usually comprises spring-loading which forms a seal between the inner part and the closure.

The back plate may be a separate, third, part of the punch but is more usually an integral part of the outer part of the punch.

The punch inner part generally includes a lip at its outer diameter, which may have a predominantly flat surface. The surface of the lip thus enables sealing with the shell and improves sealing from previous punch designs.

The outer part of the punch has a grooved portion at its radially innermost position, which forms a recess into which compound flows during moulding.

The anvil may include complementary features to the closure in order to contact the closure profile for lifting the shell. The anvil typically includes a centre core which lifts up to support the closure. A shroud may be provided as an external ring to surround the punch and align the shell on the anvil.

According to another aspect of the present invention, there is provided a closure manufactured according to the method described above, in which the closure is made from metal such as coated tinplate and has a centre panel which is substantially free of lining or gasket material.

### BRIEF DESCRIPTION OF FIGURES IN THE DRAWINGS

Preferred embodiments of the invention will now be described, by way of example, with reference to the drawings, in which:

FIG. 1 is a side section of the apparatus showing the punch position immediately after loading a closure;

FIG. 2 is in enlarged part of FIG. 1, showing the shut-off;

FIG. 3 is a side section of the apparatus showing the punch in its home position;

FIG. 4 is an enlarged part of FIG. 3, showing moulded compound; and

FIG. 5 is a side section of an apparatus similar to that of FIGS. 1 and 3, with a shroud and alignment ring.

### MODE(S) FOR CARRYING OUT THE INVENTION

In a PT closure manufacturing line, coated sheet metal is formed into closure shells by a press operation and fed along conveyor lines to a compound moulding station. A batch of viscous compound is injected by guns onto the shell inner side wall whilst the shells are on the conveyors. The shells are then fed in turn onto successive anvils on a compound moulding turret.

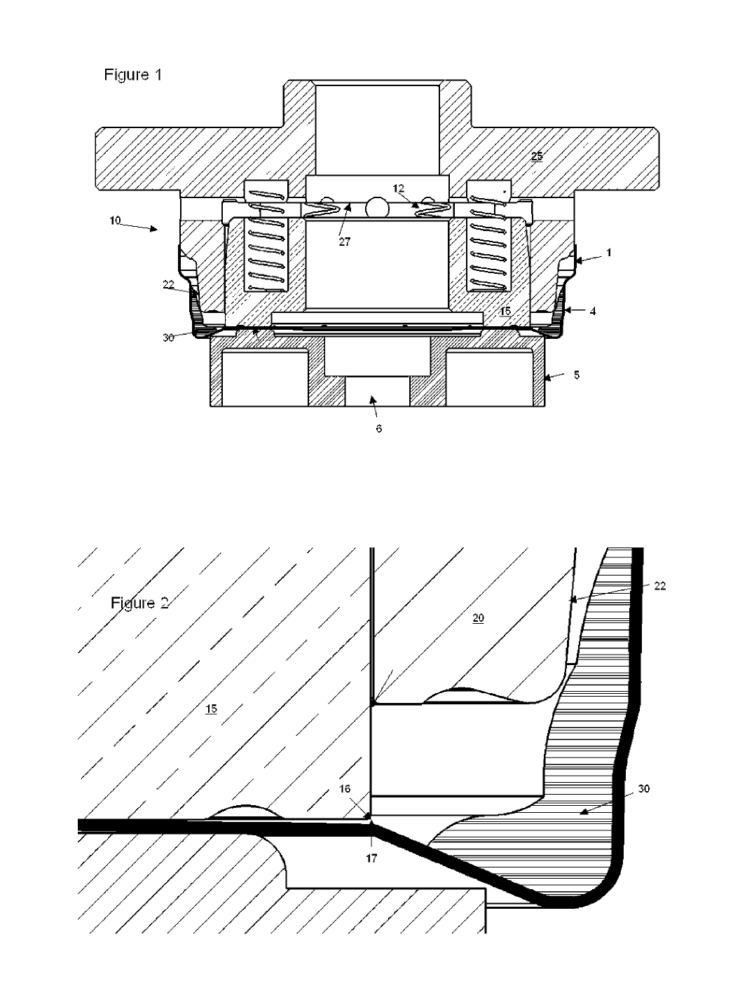

FIG. 1 shows one moulding station of the turret with closure shell 1 resting on a spring loaded anvil 5 (central anvil spring position 6). The shell 1 is in an “inverted” position such that it comprises a disc or panel 3 and a skirt 4 extending upwardly away from the panel 3 and anvil 5.

Punch 10 in FIG. 1 is in a “proud” position, i.e. prior to commencement of moulding. The punch 10 of FIG. 1 has six concentrically positioned springs 12 which hold the shell 1 against the anvil 5. The punch 10 of FIG. 1 is in two main concentric parts: inner part 15 and outer part 20. The inner part 15 is “proud” of the outer part 20, extending longitudinally away from the outer part due to the axial biasing force supplied by springs 12. In this punch position, the inner punch part 15 is simply holding the closure 1 on anvil 5.

It can be seen that punch inner 15 and punch outer 20 each have leading edges 16 and 21 respectively. Inner part leading edge 16 provides shut-off for compound moulding as is described in more detail below. The region formed between closure inner skirt wall 4, outer wall 22 of outer punch part and including, in FIG. 2, exposed part 17 of inner punch, provides a channel into which compound 30 may be moulded.

The punch 10 of FIG. 1 has two parts. Outer part 20 includes, by virtue of bolt (not shown), a backplate 25. The backplate 25 planar lower surface 27 provides a stop position for limiting upwards movement of inner punch part 15 against the action of springs 12. The punch applies a load to the centre of closure shell 1 and seals the shell centre before commencement of moulding.

As best shown in the enlarged drawing of FIG. 2, the inner part of the punch provides shut-off for limiting radially inward movement of the compound. The punch springs 12 maintain contact between the punch and the shell surface in order to avoid flashing of compound. Any flash is thus minimal and will take the path of least obstruction to the compound, i.e. back up the side wall of the closure.

The moulding station of FIG. 1 is one station on a multi-head horizontal rotary machine or moulding turret. Each station includes a static punch and a lifting anvil, between which a shell including viscous compound is introduced. The compound has been injected onto the closure side wall by a compound applicator gun along the closure line prior to the moulding station. Moulding uses a hot punch with an anvil heated indirectly by proximity to and contact with the heated elements of the moulding station.

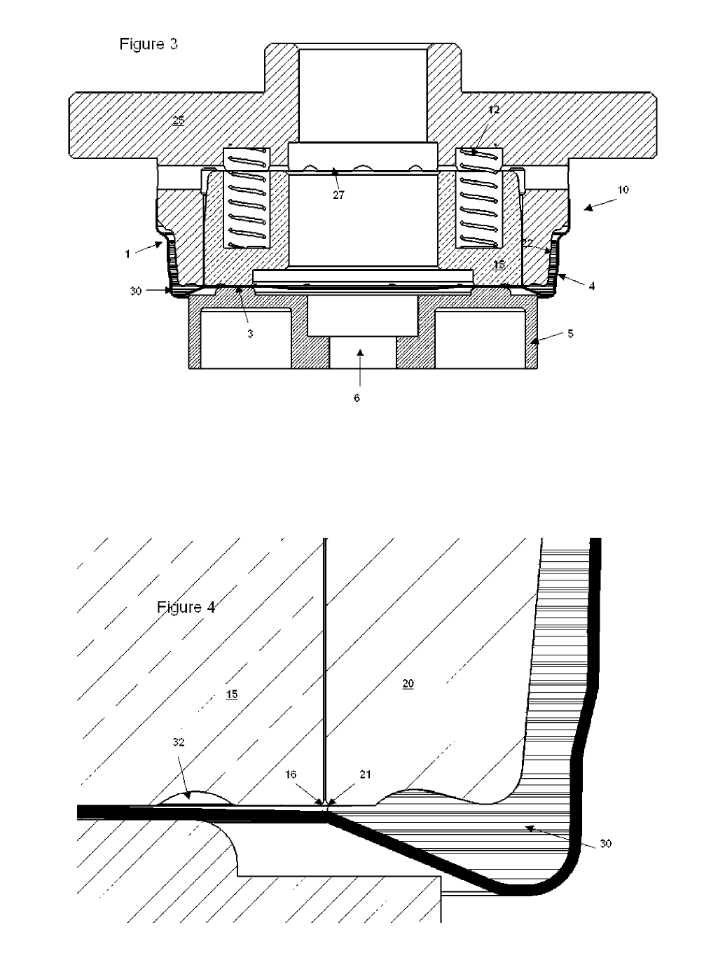

Moulding of the compound is shown in FIGS. 3 and 4 and takes place by movement of anvil 5 against the opposing biasing force of punch springs 12 (see FIG. 1 for position of punch springs 12). As the anvil lifts closure shell 1, the inner part 15 is forced to slide within concentric outer punch part 20 until stop position 27 is reached. At this position shown in FIG. 3 the loads from the punch springs 12 and the anvil spring 6 are balanced to ensure that shut-off 17 is maintained and compound is prevented from penetrating onto the shell panel centre. The net force is balanced during moulding with the anvil spring 6 providing compliance once the home position has been reached.

Both leading edges 16, 21, of punch inner and outer respectively, match when closed. The viscous compound 30 is moulded as shown in FIG. 4. Any air trapped ahead of the compound is forced past the shut-off of leading edge 16 and through the vent channels 32 out of the punch.

Compound “skins” and partially cures during moulding and also during rotation of the moulding turret. Release of compound from the punch is achieved by careful selection of temperature, coating parameters and surface material with appropriate venting. Once the shell with partially cured compound is ejected from the moulding punch, it is transferred to an oven for full curing.

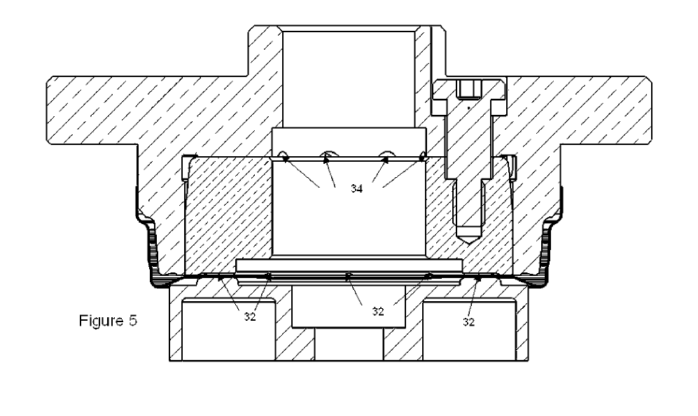

Although not essential to the invention, a shroud 35 and/or insulation 36 may be used as shown in FIG. 5.

1. An apparatus for moulding fluid lining or gasket material in a closure shell, the shell comprising an end panel and skirt extending from the end panel, in which the apparatus comprises:
an anvil for supporting the shell in its inverted position with the skirt extending upwardly; and
a punch having an inner part for holding the closure shell and a distinct outer part for moulding the fluid lining material, the inner part of the punch being axially moveable relative to the outer part, in which the inner part is a compliant component which is adapted, in use, to provide annular shut-off to limit dispersion of the fluid lining or gasket material inboard of the shut-off and
the outer part has a profile which is adapted for moulding of the lining or gasket material.

2. An apparatus according to claim 1, in which the inner part is a compressible component.

3. An apparatus according to claim 1, in which the inner part includes a biasing feature and has a profile having its leading edge at a radially outward position; and the outer part has a profile having its leading edge at a radially inward position; and in which, in use, when the punch is used for moulding, the leading edge of the inner part forms a shut-off point for limiting dispersion of the gasket or lining material.

4. An apparatus according to claim 3, in which either or both of the leading edges are coated with a coating selected so as to prevent build up of lining material during moulding.

5. An apparatus according to claim 1, in which the outer punch is fixed concentrically and the inner punch part is biased, for example by springs, towards the anvil.

6. An apparatus according to claim 1, in which the inner punch part protrudes from the outer punch part in the punch pre-loaded position.

7. An apparatus according to claim 1, in which the anvil includes a biasing feature such as one or more springs which, when the punch is loaded, bias the inner part of the punch towards a home position.

8. A method of moulding lining or gasket compound in a closure shell, the shell comprising an end panel and skirt extending from the end panel, in which the method comprises:
introducing lining compound onto the inner wall of the skirt of the shell;
supporting the closure shell in its inverted, skirt uppermost, position on an anvil; lifting the closure into contact with an inner part of a punch;
sealing an annular channel of the closure by a compliant and compressible inner part of the punch; and,
after the sealing step has provided shut-off, axially moving a distinct outer part of the punch into contact with the lining compound and moulding the compound around the inner skirt wall.

9. A method according to claim 8, further comprising moulding the compound onto an outer annulus of the end panel.

10. A method according to claim 8, further comprising biasing the anvil against an opposing biasing force from the punch, the biasing forces being provided by spring loading and/or by resilient material.

11. A method according to claim 8, in which the punch is heated to skin and at least partially cure compound during moulding.

12. A method according to claim 8, further comprising controlling the amount of compound in the shell and/or the placement of the compound on the shell wall when it is injected into the closure.

13. A closure manufactured according to the method of claim 8, in which the closure is made from metal such as coated tinplate and has a centre panel which is substantially free of lining or gasket material.

14. A closure manufactured according to the method of claim 8.

15. A closure manufactured using the apparatus of claim 1.
